(19) United States
(12) Patent Application Publication
(10) Pub. No.: US 2025/0258667 A1
(43) Pub. Date: Aug. 14, 2025

(54) SYSTEM AND METHOD FOR PERFORMING MULTI-PLATFORM SOFTWARE CODE MERGING AND MIGRATION USING HYBRID NEURAL NETWORKS

(71) Applicant: BANK OF AMERICA CORPORATION, Charlotte, NC (US)

(72) Inventors: Amit Dilip Champanerkar, Mumbai (IN); Avinash Basavant Nigudkar, Mumbai (IN); Kiran Pulla, Hyderabad (IN); Rohan D'Silva, Mumbai (IN); Lingaraj Gopalakrishnan, Chennai (IN); Rajendra Uttamrao Pradhan, Mumbai (IN)

(73) Assignee: BANK OF AMERICA CORPORATION, Charlotte, NC (US)

(21) Appl. No.: 18/440,295

(22) Filed: Feb. 13, 2024

(51) Int. Cl. G06F 8/71; G06F 8/41; G06F 8/51; G06F 8/60

(52) U.S. Cl. CPC G06F 8/71; G06F 8/4435; G06F 8/51; G06F 8/60

(57) ABSTRACT

Embodiments of the present invention provide a system for performing multi-platform software code merging and migration using hybrid neural networks. The system is configured for identifying source files in a software code development environment, wherein each of the source files comprise software code associated with entity applications that is developed by one or more users in one or more software programming languages, translating the software code in each of the source files that is developed in the one or more software programming languages into a translated code that is in a first software programming language, merging the translated code associated with the software code in each of the source files into a unified code, wherein the unified code is in the first software programming language, automatically performing build and packaging of the unified code for deployment, and automatically deploying the packaged unified code into a software code production environment.

### BACKGROUND

There exists a need for a system for performing multi-platform software code merging and migration using hybrid neural networks.

### BRIEF SUMMARY

Embodiments of the present invention address the above needs and/or achieve other advantages by providing apparatuses (e.g., a system, computer program product and/or other devices) and methods for performing multi-platform software code merging and migration using hybrid neural networks. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies one or more source files in a software code development environment, wherein each of the one or more source files comprises software code associated with one or more entity applications that is developed by one or more users in one or more software programming languages, translates the software code in each of the one or more source files that is developed in the one or more software programming languages into a translated code that is in a first software programming language, via a transformer based sequence-to-sequence model, merges the translated code associated with the software code in each of the source files into a unified code, wherein the unified code is in the first software programming language, automatically performs build and packaging of the unified code for deployment, and automatically deploys the packaged unified code into a software code production environment.

In some embodiments, merging the translated code associated with the software code in each of the one or more source files comprises analyzing the translated code to detect duplicate code snippets in the translated code and in response to detecting the duplicate code snippets in the translated code, isolating the duplicate code snippets from the translated code.

In some embodiments, merging the translated code associated with the software code in each of the one or more source files comprises analyzing the translated code to identify one or more patterns associated with one or more known conflicts, via a Siamese neural network, determining that the one or more patterns in the translated code causes merge conflicts during deployment, and performing one or more corrective measures to resolve the merge conflicts.

In some embodiments, the present invention merges the translated code associated with the software code in each of the one or more source files based on one or more historical merge patterns.

In some embodiments, the present invention trains the transformer based sequence-to-sequence model based on historical snippets of code in each of the one or more software programming languages comprising the first software programming language.

In some embodiments, the present invention provides a virtual environment to the one or more users to allow the one or more users to perform one or more software code related operations associated with the one or more entity applications.

In some embodiments, the present invention provides a digital twin of software code environments comprising the software code development environment, software code testing environment, and the software code production environment, allows the one or more users to perform one or more software code related operations associated with the one or more entity applications in the digital twin, determines that the one or more software code related operations are successful, and implements the one or more software code related operations performed in the digital twin in the software code environments.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for performing multi-platform software code merging and migration using hybrid neural networks, in accordance with an embodiment of the invention;

FIG. 2 provides a block diagram illustrating the entity system 200 of FIG. 1, in accordance with an embodiment of the invention;

FIG. 3 provides a block diagram illustrating an software code merging and migration system 300 of FIG. 1, in accordance with an embodiment of the invention;

FIG. 4 provides a block diagram illustrating the computing device system 400 of FIG. 1, in accordance with an embodiment of the invention;

FIGS. 5A and 5B provide a process flow for performing multi-platform software code merging and migration using hybrid neural networks, in accordance with an embodiment of the invention;

FIG. 6 provides a block diagram illustrating a transformer sequence-to-sequence model used by the software code merging and migration system 300 for translating software code from one or more software code programming languages to a first software code programming language, in accordance with an embodiment of the invention; and

FIG. 7 provides a block diagram for performing multi-platform software code merging and migration using hybrid neural networks, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that creates, manages, develops, provides, maintains, and/or uses one or more applications (e.g., web applications, mobile applications, or the like) to perform one or more activities. In some embodiments, the entity may be a financial institution which may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to develop, access, and/or use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, different applications are developed by an entity in different programming languages, where each of these different applications may be performing a specific operation related to a process associated with the entity. For example, an entity may be an e-commerce company which may develop applications such as a catalog services application that is developed in Python, an order processing application that is developed in Java, a supply chain analytics application that is developed in C++, and/or the like, where each of these applications are part of the e-commerce process of selling goods and services to customers. Development of entity applications in multiple programming languages may lead to challenges related to quality and reliability as each programming language has different syntaxes and rules, thereby complicating the process of merging code associated with multiple applications in order to support a process associated with the entity. In addition, each programming language may use different libraries, Application Programming Interfaces, and/or the like during the development of different entity applications, where programming language specific libraries may not have equivalents in other programming languages which adds to the complexity of the code merging process between different entity applications. Furthermore, it is difficult to optimize the overall performance of the process involving the different applications developed in multiple programming languages, thereby decreasing the overall processing efficiency of entity systems associated with the process. As such, there exists a need for a system that overcomes these technical problems and perform multi-platform software code merging and migration. The system of the invention provides technical solution to this problem as discussed in detail below.

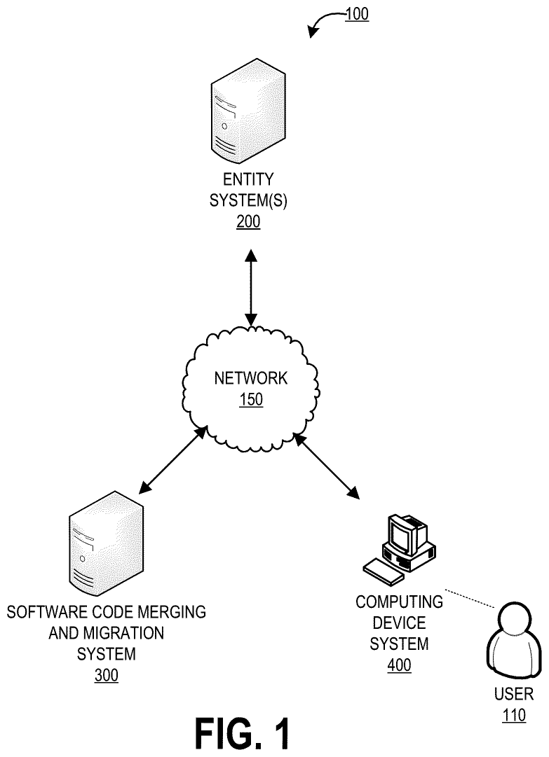

FIG. 1 provides a block diagram illustrating a system environment 100 for performing multi-platform software code merging and migration using hybrid neural networks, in accordance with an embodiment of the invention. As illustrated in FIG. 1, the environment 100 includes a software code merging and migration system 300, entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200 (e.g., software engineer, application developer, application tester, and/or the like). In some embodiments, the one or more user(s) 110 of the system environment 100 may further comprise end-users which may include, but are not limited to, customers, potential customers, or the like of the entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution.

The software code merging and migration system 300 is a system of the present invention for performing one or more process steps described herein. In some embodiments, the software code merging and migration system 300 may be an independent system. In some embodiments, the software code merging and migration system 300 may be a part of the entity system 200.

The software code merging and migration system 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the software code merging and migration system 300 is configured to communicate information or instructions with the entity system 200, and/or the computing device system 400 across the network 150.

The computing device system 400 may be a computing device of the user 110. In general, the computing device system 400 communicates with the user 110 via a user interface of the computing device system 400, and in turn is configured to communicate information or instructions with the software code merging and migration system 300 and/or entity system 200 across the network 150.

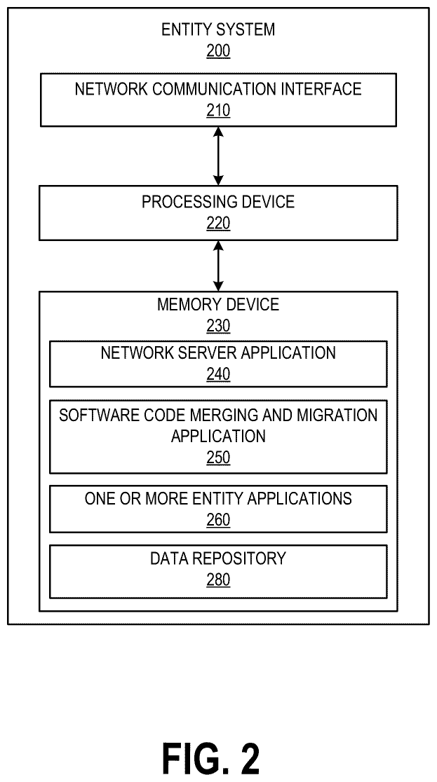

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a software code merging and migration application 250, one or more entity applications 260, and a data repository 280. The computer-executable program code of the network server application 240, the software code merging and migration application 250, and the one or more entity applications 260 to perform certain logic, data-extraction, and data-storing functions of the entity system 200 described herein, as well as communication functions of the entity system 200.

The network server application 240, the software code merging and migration application 250, and the one or more entity applications 260 are configured to store data in the data repository 280 or to use the data stored in the data repository 280 when communicating through the network communication interface 210 with the software code merging and migration system 300, and the computing device system 400 to perform one or more process steps described herein. In some embodiments, the entity system 200 may receive instructions from the software code merging and migration system 300 via the software code merging and migration application 250 to perform certain operations. The software code merging and migration application 250 may be provided by the software code merging and migration system 300.

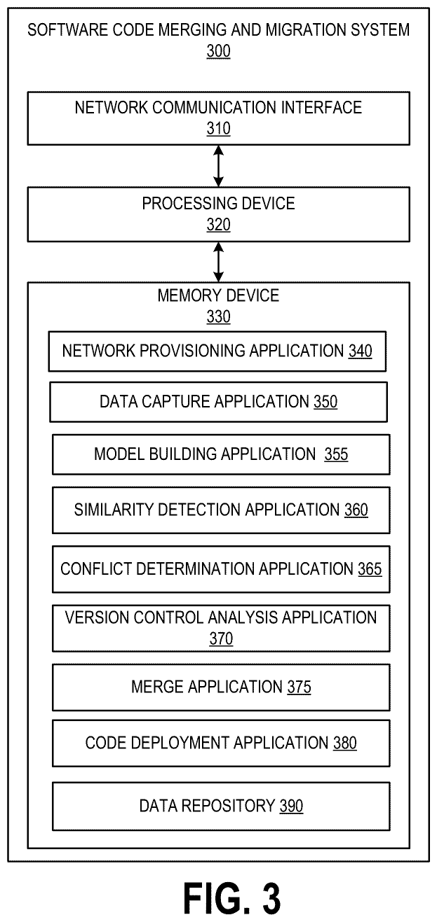

FIG. 3 provides a block diagram illustrating the software code merging and migration system 300 in greater detail, in accordance with embodiments of the invention. As illustrated in FIG. 3, in one embodiment of the invention, the software code merging and migration system 300 includes one or more processing devices 320 operatively coupled to a network communication interface 310 and a memory device 330. In certain embodiments, the software code merging and migration system 300 is operated by an entity, such as a financial institution, while in other embodiments, the software code merging and migration system 300 is operated by an entity other than a financial institution. In some embodiments, the software code merging and migration system 300 is owned or operated by the entity of the entity system 200. In some embodiments, the software code merging and migration system 300 may be an independent system. In alternate embodiments, the software code merging and migration system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the software code merging and migration system 300 described herein. For example, in one embodiment of the software code merging and migration system 300, the memory device 330 includes, but is not limited to, a network provisioning application 340, a data capture application 350, a model building application 355, a similarity detection application 360, a conflict determination application 365, a version control analysis application 370, a merge application 375, a code deployment application 380, and a data repository 390 comprising data processed or accessed by one or more applications in the memory device 330. The computer-executable program code of the network provisioning application 340, the data capture application 350, the model building application 355, the similarity detection application 360, the conflict determination application 365, the version control analysis application 370, the merge application 375, and the code deployment application 380 may instruct the processing device 320 to perform certain logic, data-processing, and data-storing functions of the software code merging and migration system 300 described herein, as well as communication functions of the software code merging and migration system 300.

The network provisioning application 340, the data capture application 350, the model building application 355, the similarity detection application 360, the conflict determination application 365, the version control analysis application 370, the merge application 375, and the code deployment application 380 are configured to invoke or use the data in the data repository 390 when communicating through the network communication interface 310 with the entity system 200, and the computing device system 400. In some embodiments, the network provisioning application 340, the data capture application 350, the model building application 355, the similarity detection application 360, the conflict determination application 365, the version control analysis application 370, the merge application 375, and the code deployment application 380 may store the data extracted or received from the entity system 200 and the computing device system 400 in the data repository 390. In some embodiments, the network provisioning application 340, the data capture application 350, the model building application 355, the similarity detection application 360, the conflict determination application 365, the version control analysis application 370, the merge application 375, and the code deployment application 380 may be a part of a single application. One or more processes performed by the network provisioning application 340, the data capture application 350, the model building application 355, the similarity detection application 360, the conflict determination application 365, the version control analysis application 370, the merge application 375, and the code deployment application 380 are described in detail below.

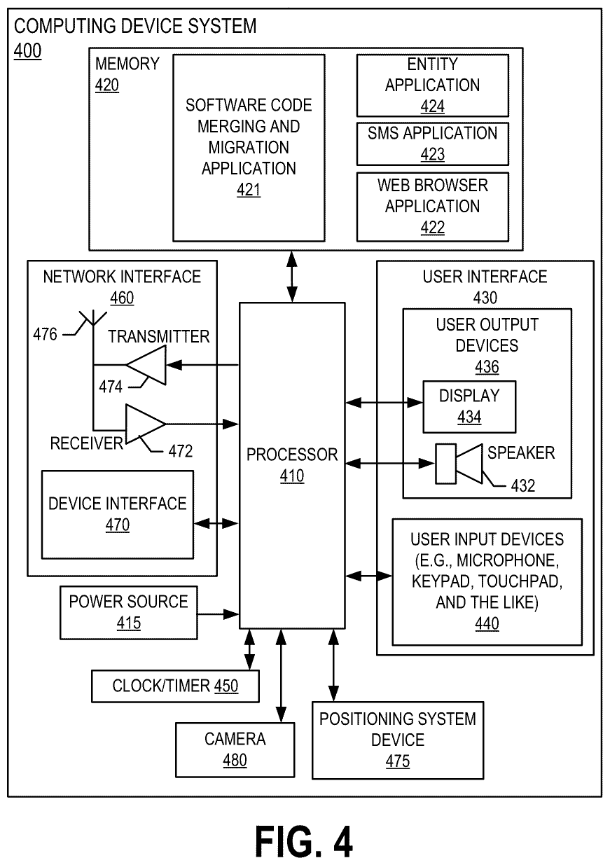

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a software code merging and migration application 421, an entity application 424, or the like. These applications also typically instructions to a graphical user interface (GUI) on the display 430 that allows the user 110 to interact with the entity system 200, the software code merging and migration system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

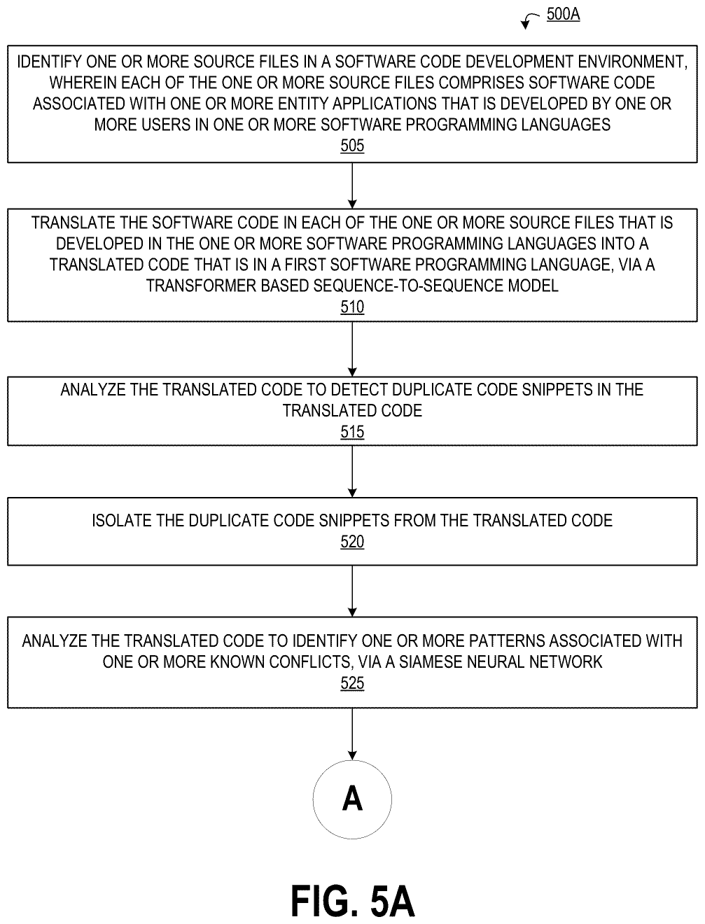

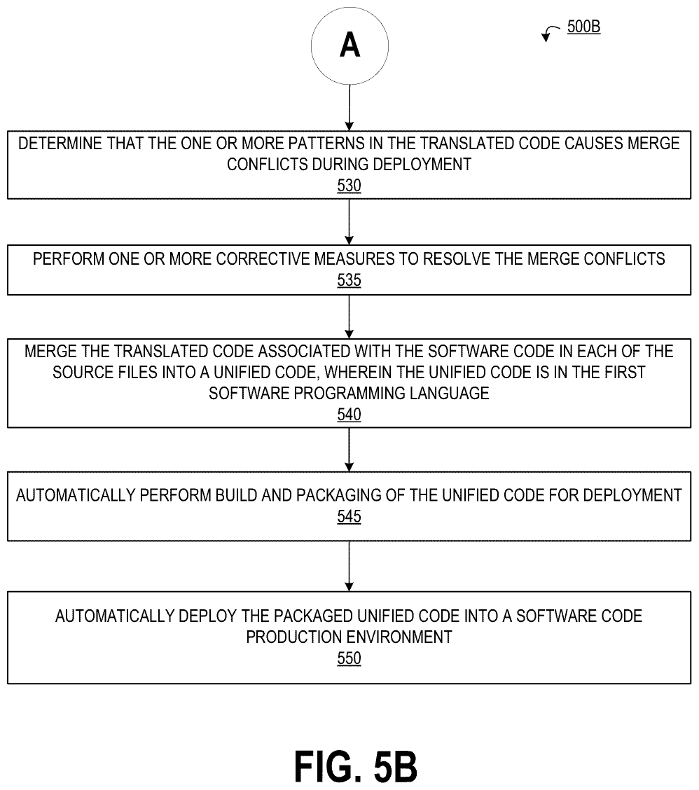

FIGS. 5A and 5B provide a process flow for performing multi-platform software code merging and migration using hybrid neural networks, in accordance with an embodiment of the invention. As shown in block 505, the system identifies one or more source files in a software code development environment, wherein each of the one or more source files comprises software code associated with one or more entity applications that is developed by one or more users in one or more software programming languages. One or more users may include employees, contractors, part-time employees, and/or the like associated with the entity. In some embodiments, the one or more users may be software application developers, application testers, software engineers, and/or the like that are involved in the software development lifecycle process of the entity applications. The one or more users may develop the software code associated with one or more functionalities of the entity applications (via the computing device system 400) and may store the one or more source files comprising the software code in a code repository associated with corresponding entity applications in a software code development environment (e.g., a server in a plurality of entity systems 200). In some embodiments, the system may continuously monitor the software code development environment and may identify the one or more source files that are being saved to the software code development environment by the one or more users.

As shown in block 510, the system translates the software code in each of the one or more source files that is developed in the one or more software programming languages into a translated code that is in a first software programming language, via a transformer based sequence-to-sequence model. In some embodiments, the first software programming language may be predetermined. In some embodiments, the first software programming language may be determined by the system automatically based on advantages of programming languages and/or the entity process using the entity applications. In some embodiments, the first software programming language may be based determined based on input from the one or more users associated with the entity. In some embodiments, the first software programming language may be determined by the system dynamically based on new advancements in technology or tools associated with the one or more software programming languages. For example, the system may determine that a new efficient tool associated with building and package software code is available for software programming language ‘A’ the system may dynamically convert the software code and/or the previously existing software code (that may have been already translated into another programming language) in the one or more source files to the software programming language ‘A.’ The transformed based sequence-to-sequence model employed by the system translates the software code from one or more software code programming languages to the first software code programming language.

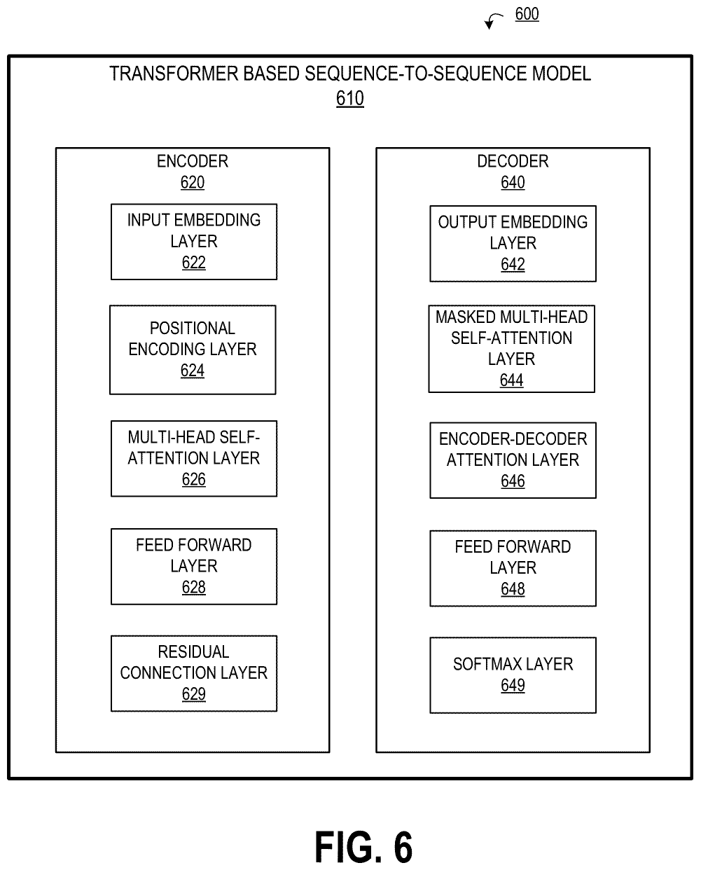

FIG. 6 provides a block diagram illustrating the transformer sequence-to-sequence model used by the software code merging and migration system 300 for translating software code from one or more software code programming languages to the first software code programming language, in accordance with an embodiment of the invention. As shown, the transformer sequence-to-sequence model 610 comprises an encoder 620 and a decoder 640. The encoder 620 further comprises one or more layers which may include, but are not limited to, an input embedding layer 622, a positional encoding layer 624, a multi-head self-attention layer 626, a feed forward layer 628, and a residual connection layer 629. The input embedding layer 622 of the encoder assigns vectors to one or more tokens of the software code (e.g., sequences, words, variables, functions, or the like) in the one or more source files and analyzes the vector representation of the software code to capture semantics associated with the software code. The positional encoding layer 624 provides positional information associated with vectors, where the positional information provides positions of one or more tokens associated with each of the vectors in the software code. The multi-head self-attention layer 626 identifies dependencies within the software code which gives context associated with the software code. The feed forward layer 628 captures complex patterns and relationships between the one or more tokens in the software code. The residual connection layer 629 skips connections between layers to help with training and convergence of the transformer sequence-to-sequence model 610. The encoder 620 captures the semantics and structure associated with the software code in the one or more source files and provides one or more output sequences to the decoder 640. The decoder 640 comprises an output embedding layer 642, a masked multi-head self-attention layer 644, an encoder-decoder attention layer 646, a feedforward layer 648, and a SoftMax layer 649. The output embedding layer 642 maps target code token IDs to continuous vectors and for each of the output sequences generated by the encoder 620, the output embedding layer 642 generates corresponding target output sequences. The masked multi-head self-attention layer 644 excludes processing associated with future context that is not yet generated. The encoder-decoder attention layer 646 focusses on relevant source code parts for generating the target translated code. The feedforward layer 648 further processes the context vectors and produces predictions. The SoftMax layer 649 predicts probability distribution associated with target translated vocabulary. The decoder 640 generated translated target code sequence based on the output of the encoder 620. Once the software code is translated to the first software programming language, the process proceeds to block 515.

As shown in block 515, the system analyzes the translated code to detect duplicate code snippets in the translated code. The system may analyze the translated code to detect similarities between different modules or snippets of the code. As shown in block 520, the system isolates the duplicate code snippets from the translated code. In some embodiments, the system may delete the duplicate code snippets. In some embodiments, the system may comment out the supplicate code snippets instead of deleting the code snippets. In some embodiments, the system skips the steps described in block 520 and may notify the user along with the notifications transmitted in block 535.

As shown in block 525, the system analyzes the translated code to identify one or more patterns associated with one or more known conflicts, via a Siamese neural network. Siamese neural network is an artificial neural network that uses the same weights while working in tandem on two different input vectors to compute comparable output vectors. During merging of code, conflicts may occur due to conflicting changes made by different developers in the software code. The Siamese neural network is trained on historical data to identify the one or more patterns that can lead to potential conflicts during merging of the code. As shown in block 530, the system determines that the one or more patterns in the translated code causes merge conflicts during deployment. As shown in block 535, the system performs one or more corrective measures to resolve the merge conflicts. The one or more corrective measures may comprise alerting the one or more users, providing a solution to the one or more users to resolve the conflict, automatically implementing a resolution to resolve the conflict based on historical corrective measure data, and/or the like.

As shown in block 540, the system merges the translated code associated with the software code in each of the source files into a unified code, wherein the unified code is in the first software programming language. In some embodiments, the system may generate insights, trends, or data associated with merging of the translated code that aids in optimizing the merging process. To generate the insights, the system may track (i) commit histories of the software code in the software code development environment by the one or more users, (ii) branching patterns, (iii) merging patterns, and/or the like.

As shown in block 545, the system automatically performs build and packaging of the unified code for deployment. At the this stage, the system does not need multiple build and packaging tools and also does not need to adhere to different build and packing requirements associated with all of the one or more software programming languages. The system packages the unified code using the build and packaging tools and requirements associated with the first software programming language. As shown in block 550, the system automatically deploys the packaged unified code into a software code production environment.

In some embodiments, the system may provide a virtual environment to the one or more users to allow the one or more users to perform one or more software code related operations associated with the one or more entity applications. For example, the system may allow developers to develop and test code via the virtual environment (e.g., via virtual reality devices, augmented reality devices, or the like) and may also allow the user to perform or view steps described in FIGS. 5A and 5B.

In some embodiments, the present invention provides a digital twin of software code environments comprising the software code development environment, software code testing environment, and the software code production environment, allows the one or more users to perform one or more software code related operations associated with the one or more entity applications in the digital twin, determines that the one or more software code related operations are successful, and implements the one or more software code related operations performed in the digital twin in the software code environments. For example, the system may allow users to develop and test changes in the digital twin without causing interruptions to end users of the entity applications.

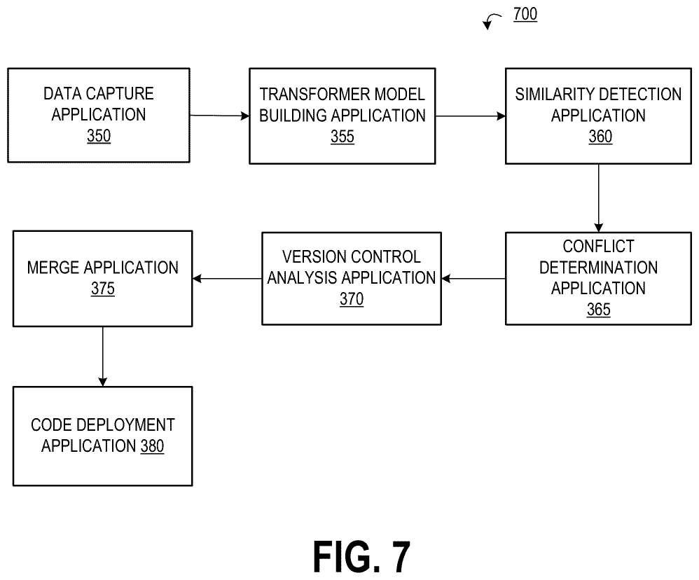

FIG. 7 provides a block diagram for performing multi-platform software code merging and migration using hybrid neural networks, in accordance with an embodiment of the invention. As shown, the data capture application 350 identifies the one or more source files comprising the software code that are being added to the software code development environment by the one or more users. The transformer model building application 355 builds the transformer sequence-to-sequence model to transform the software code in the one or more software programming languages into the first software programming language. The transformer sequence-to-sequence model is trained by the system 300 using historical snippets of program code in the one or more software programming languages. In some embodiments, in response to the data capture application 350 identifying the one or more source files, the transformer model building application 355 tunes the transformer sequence-to-sequence model to the specific software code, software programming language, entity application associated with the software code, and/or the like, where the transformer sequence-to-sequence model built by the transformer model building application 355 translates the software code that is in one or more software programming languages to the first software programming language. The similarity detection application 360 detects similarities between different snippets of the translated code and may further determine if any of the similarities may results in any merging issues. The conflict determination application 365 analyzes the translated code to identify any one or more patterns associated with known conflicts and may take the one or more corrective measures to resolve the detected conflicts. The version control analysis application 370 generates one or more insights that aids the optimization of the merging process. The merge application 375 merges the translated code associated with different entity application. The code deployment application 380 builds and packages the translated code and then automatically deploys the packaged code to the software code production environment in real-time.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for performing multi-platform software code merging and migration using hybrid neural networks, comprising:
at least one processing device;
at least one memory device; and
a module stored in the at least one memory device comprising executable instructions that when executed by the at least one processing device, cause the at least one processing device to:
identify one or more source files in a software code development environment, wherein each of the one or more source files comprises software code associated with one or more entity applications that is developed by one or more users in one or more software programming languages;
translate the software code in each of the one or more source files that is developed in the one or more software programming languages into a translated code that is in a first software programming language, via a transformer based sequence-to-sequence model;
merge the translated code associated with the software code in each of the one or more source files into a unified code, wherein the unified code is in the first software programming language;
automatically perform build and packaging of the unified code for deployment; and
automatically deploy the packaged unified code into a software code production environment.

2. The system according to claim 1, wherein merging the translated code associated with the software code in each of the one or more source files comprises:
analyzing the translated code to detect duplicate code snippets in the translated code; and
in response to detecting the duplicate code snippets in the translated code, isolating the duplicate code snippets from the translated code.

3. The system according to claim 1, wherein merging the translated code associated with the software code in each of the one or more source files comprises:
analyzing the translated code to identify one or more patterns associated with one or more known conflicts, via a Siamese neural network;
determining that the one or more patterns in the translated code causes merge conflicts during deployment; and
performing one or more corrective measures to resolve the merge conflicts.

4. The system according to claim 1, wherein the executable instructions cause the at least one processing device to merge the translated code associated with the software code in each of the one or more source files based on one or more historical merge patterns.

5. The system according to claim 1, wherein the executable instructions cause the at least one processing device to:
train the transformer based sequence-to-sequence model based on historical snippets of code in each of the one or more software programming languages comprising the first software programming language.

6. The system according to claim 1, wherein the executable instructions cause the at least one processing device to:
provide a virtual environment to the one or more users to allow the one or more users to perform one or more software code related operations associated with the one or more entity applications.

7. The system according to claim 1, wherein the executable instructions cause the at least one processing device to:
provide a digital twin of software code environments comprising the software code development environment, software code testing environment, and the software code production environment;
allow the one or more users to perform one or more software code related operations associated with the one or more entity applications in the digital twin;
determine that the one or more software code related operations are successful; and
implement the one or more software code related operations performed in the digital twin in the software code environments.

8. A computer program product for performing multi-platform software code merging and migration using hybrid neural networks, comprising a non-transitory computer-readable storage medium having computer-executable instructions for:
identifying one or more source files in a software code development environment, wherein each of the one or more source files comprises software code associated with one or more entity applications that is developed by one or more users in one or more software programming languages;
translating the software code in each of the one or more source files that is developed in the one or more software programming languages into a translated code that is in a first software programming language, via a transformer based sequence-to-sequence model;
merging the translated code associated with the software code in each of the one or more source files into a unified code, wherein the unified code is in the first software programming language;
automatically performing build and packaging of the unified code for deployment; and
automatically deploying the packaged unified code into a software code production environment.

9. The computer program product according to claim 8, wherein merging the translated code associated with the software code in each of the one or more source files comprises:
analyzing the translated code to detect duplicate code snippets in the translated code; and
in response to detecting the duplicate code snippets in the translated code, isolating the duplicate code snippets from the translated code.

10. The computer program product according to claim 8, wherein merging the translated code associated with the software code in each of the one or more source files comprises:
analyzing the translated code to identify one or more patterns associated with one or more known conflicts, via a Siamese neural network;
determining that the one or more patterns in the translated code causes merge conflicts during deployment; and
performing one or more corrective measures to resolve the merge conflicts.

11. The computer program product according to claim 8, wherein the non-transitory computer-readable storage medium comprises computer-executable instructions for merging the translated code associated with the software code in each of the one or more source files based on one or more historical merge patterns.

12. The computer program product according to claim 8, wherein the non-transitory computer-readable storage medium comprises computer-executable instructions for:
providing a digital twin of software code environments comprising the software code development environment, software code testing environment, and the software code production environment;
allowing the one or more users to perform one or more software code related operations associated with the one or more entity applications in the digital twin;
determining that the one or more software code related operations are successful; and
implementing the one or more software code related operations performed in the digital twin in the software code environments.

13. The computer program product according to claim 8, wherein the non-transitory computer-readable storage medium comprises computer-executable instructions for training the transformer based sequence-to-sequence model based on historical snippets of code in each of the one or more software programming languages comprising the first software programming language.

14. The computer program product according to claim 8, wherein the non-transitory computer-readable storage medium comprises computer-executable instructions for providing a virtual environment to the one or more users to allow the one or more users to perform one or more software code related operations associated with the one or more entity applications.

15. A computerized method for performing multi-platform software code merging and migration using hybrid neural networks, the method comprising:
identifying one or more source files in a software code development environment, wherein each of the one or more source files comprises software code associated with one or more entity applications that is developed by one or more users in one or more software programming languages;
translating the software code in each of the one or more source files that is developed in the one or more software programming languages into a translated code that is in a first software programming language, via a transformer based sequence-to-sequence model;
merging the translated code associated with the software code in each of the one or more source files into a unified code, wherein the unified code is in the first software programming language;
automatically performing build and packaging of the unified code for deployment; and
automatically deploying the packaged unified code into a software code production environment.

16. The computerized method according to claim 15, wherein merging the translated code associated with the software code in each of the one or more source files comprises:
analyzing the translated code to detect duplicate code snippets in the translated code; and
in response to detecting the duplicate code snippets in the translated code, isolating the duplicate code snippets from the translated code.

17. The computerized method according to claim 15, wherein merging the translated code associated with the software code in each of the one or more source files comprises:
analyzing the translated code to identify one or more patterns associated with one or more known conflicts, via a Siamese neural network;
determining that the one or more patterns in the translated code causes merge conflicts during deployment; and
performing one or more corrective measures to resolve the merge conflicts.

18. The computerized method according to claim 15, wherein the method comprises:
providing a digital twin of software code environments comprising the software code development environment, software code testing environment, and the software code production environment;
allowing the one or more users to perform one or more software code related operations associated with the one or more entity applications in the digital twin;
determining that the one or more software code related operations are successful; and
implementing the one or more software code related operations performed in the digital twin in the software code environments.

19. The computerized method according to claim 15, wherein the method comprises training the transformer based sequence-to-sequence model based on historical snippets of code in each of the one or more software programming languages comprising the first software programming language.

20. The computerized method according to claim 15, wherein the method comprises providing a virtual environment to the one or more users to allow the one or more users to perform one or more software code related operations associated with the one or more entity applications.
